(19) United States
(12) Patent Application Publication
(10) Pub. No.: US 2002/0065813 A1
(43) Pub. Date: May 30, 2002

(54) Image relationships derived from thresholding of historically tracked user data for facilitating image based searching

(76) Inventors: Henry R. Scanlon, Saddle River, NJ (US); Derek Sasaki-Scanlon, Summit, NJ (US); Derek Ohly, Arlington, MA (US); Bryan Frederick, Brentwood, NH (US)

Correspondence Address: GOTTLIEB RACKMAN & REISMAN PC, 270 MADISON AVENUE, 8TH FLOOR, NEW YORK, NY, 100160601

(21) Appl. No.: 09/837,118

(22) Filed: Apr. 18, 2001

Related U.S. Application Data
(60) Provisional application No. 60/197,710, filed on Apr. 18, 2000.

(51) Int. Cl. G06F 7/00

(52) U.S. Cl. 707/3

(57) ABSTRACT

A method and related computer systems for searching or locating a goal image from a collection of images. A database or collection of images is analyzed to record non-verbal associations between images for later use. These non-verbal associations record visual associations without the use of words to describe the basis of the association. To locate a goal image, a launch element relating to a goal image is selected. Suggested images are displayed based upon the recorded associations between the launch element and the suggested images. In the preferred embodiment of the invention, the recording of non-verbal associations is performed while searching for a goal image. The associations are determined from the demonstrated interest of image seekers while searching for their goal images.

This application claims the Apr. 18, 2000 priority filing date of U.S. Provisional Application Serial No. 60/197,710.

### BACKGROUND OF THE INVENTION

Historically, people needing images that they had no desire to produce themselves obtained them from stock photography agencies. Stock photography agencies are firms that are in the business of storing, cataloging, retrieving and licensing images, usually for a fee. In the traditional stock photography business model, the agency would accumulate a library of hundreds of thousands and in some cases millions of images, usually in the form of color transparencies. The images were stored in file cabinets and organized by subject categories and various levels of sub-categories.

Typically, a customer interested in an image would describe the characteristics of his “goal-image” over the telephone to a researcher. The researcher would then use his (or her) knowledge and experience in conjunction with the information provided by the customer to search through the agency's files. Since it was usually not possible to send every potentially-suitable image to the client for review, an important part of the researcher's job was to present the best possible selection of images to the customer. Through careful questioning, the very best researchers were able to ascertain the creative needs the image had to fulfill and would not only include obviously relevant images but also alternative images that expressed that concept but were not necessarily exactly what the customer had originally pictured in his mind.

Once a selection of photographs was prepared, copies of the photographs would be sent by mail or courier to the customer. If the customer liked one of the photographs he would arrange to purchase a license to use it and would have the photograph digitally scanned for production. Ultimately, all of the photographs sent out as part of a selection would have to be returned to the agency, even the photograph(s) which had been licensed for use. The process of selecting, mailing and retrieving images was expensive and time consuming and, not infrequently, photographs were damaged or lost in the process.

Shortly after relatively low-cost microcomputers became available, some stock photography agencies began to create database files and lookup mechanisms that related “keywords” to individual images. In these systems, before an image was added to an agency's files, employees of the agency would inspect the image and decide upon descriptive keywords to apply to it. These keywords were then stored in data files in the computer along with the image number. When a customer requested a selection, instead of the researchers combing through the file drawers, they would search for one or more keywords using the computer. The computer search would result in a list of image numbers to which the keyword(s) had been applied. The researchers could then pull the images from the file drawers manually by number and decide which to send to the customer. As microcomputers became more powerful and storage space on computers became less expensive, agencies began scanning the images and storing them as digital files on their computers. Once this had been accomplished, keyword searches using the computer resulted in a list of viewable images, displayed on the screen, without the need to rely on a manual image number search.

Widespread use of the Internet has recently added a new dimension to the process of locating images. With proper programming, a website can make images accessible to anybody located anywhere in the world who has an Internet connection, a browser and the proper authorization. In these circumstances, the person searching for an image performs the research function himself on a computer screen. Relying on the image-seeker to perform the role formally exercised by a researcher has cost advantages for the stock photo agency as well as the customer. However, it removes Efrom the process the advantages that trained, experienced researchers offered in terms of familiarity with the contents of the agency's library and skill at helping the imageseeker define the goal of his search. This is especially important when the library of images stored online is large. Moreover, the problems associated with having image seekers perform their own research is compounded by the number of inexperienced image-seekers who, due to access via Internet search engines, are new to the process.

At first glance, using keywords to locate images on a website appears to be a good way to help the image-seeker find the goal-image. Typically, the image-seeker enters a keyword and in response is shown one or more web pages containing those images to which that keyword has been assigned. To speed up the viewing process, these pages contain multiple, small “thumbnail” images organized into rows and columns. The image-seeker glances quickly at the thumbnails looking for specific images of interest. When he spots an image that captures his attention, he clicks on it to display a somewhat larger version, sometimes called a “comping image,” that he can inspect more closely. On many websites, he can move images onto a virtual “lightbox” to which he can subsequently return. Ultimately, if he decides to purchase an image, he can move it to a virtual “shopping cart” and from there execute a series of steps that culminate in a charge to his credit card and access to a high-resolution image by download to his local computer.

Although keywords do provide a means for narrowing down the number of images the image-seeker must search through, using keywords as the basis for an image search suffers from a number of serious limitations. First, creating keywords is a tedious, labor-intensive and inherently arbitrary process. Applying keywords is fairly straight-forward when the images are of simple, concrete objects that can be described by a simple noun such as apple, milk, broom, and the like. However, when the content of an image is more complex and/or subtle, chances are that no two people will come up with the exact same collection of keywords to describe the image. This is especially true if an attempt is made to create nuanced keywords.

Second, as distinctions of greater subtlety are made, the number of keywords that are likely to apply to a particular image will increase. As this occurs, the people doing the keywording are likely to disagree as to what keywords should be used.

Third, all keywords applied to an image have an equal “weight.” When many keywords are used to define an image, the image will be found for a search even when the keyword represents only a minor feature of the image. When the image library is large, this means that searches can return an unmanageable number of images, many of which are inappropriate. The difficulty is compounded if as many synonyms as possible for each keyword have also been added to the list.

Fourth, misdirected searches can result from the use of keywords that have multiple meanings. For example, a search for “arms” might well return a mixture of images, some incorporating human appendages and others weapons.

Fifth, unless the image-seeker enters the precise keyword, an image that might be exactly what he is looking for may never appear before him, even though it is actually present in the files.

Finally, keywords are language-specific and must be translated to make them accessible to those who need or want to perform the search in a language other than the one in which the keywords were originally created. However, such translations may cause additional search problems where keywords are not directly translatable.

The greatest weakness of the traditional keywording process is the limiting nature of language when attempting to describe imagery. Indeed, searching for images using words suffers from the same limitations as searching for music using words. A superior approach would relate images through visual cues. Such an approach would allow for a much more powerful and accurate image search. The search would cross language barriers. It would no longer be necessary to re-keyword images for each language, or contend with the inaccuracies of translating keywords. Visual connections are constant between languages, allowing for minor cultural differences, creating a more robust searching tool.

### SUMMARY OF THE INVENTION

An objective of the present invention is to improve methods for searching a collection of images to identify images from the collection that embody or reflect particular visual concepts.

A further objective is to provide a searchable non-verbal means for associating visual images.

A still further objective of the present invention is to provide an efficient method for developing the collection of non-verbal associated images.

Additional objectives will be apparent from the following description of the invention.

Consistent with the aforementioned objectives, the present invention involves a system using a method of linking images based upon visual perception. Images are organized or stored in a manner to allow the selection of groups of images that have been linked by non-verbal associations; that is, visual associations that do not rely upon words or any other symbolism to describe the basis of the association. Thus, when a particular image is selected by a person having a particular interest in mind, additional images, which have been previously linked to the selected image, may be displayed or suggested based upon the pre-recorded visual associations. By linking imagery on the basis of these visual or non-verbal associations, the innovation overcomes many if not all of the limitations of traditional keywording of images.

In the preferred method for implementing the system, visual associations or links are dynamically developed during the course of multiple image searches using either traditional search approaches, the present visual approach or a combination of the present and the traditional approaches. By analyzing the relationship between keywords entered and images viewed by image seekers in the course of a search, the system records for later use non-verbal relationships that exist among keywords and images as well as from one image to other images. Using this strategy, the expenditure of effort by the stock photography agency personnel in the development of a database of associated images may be substantially alleviated.

This development method is based upon the premise that when a person is searching for a particular image, some perceived relationship exists among the images at which the person directs his or her attention. However, it is not necessary to define the perceived relationship. Rather, by recording the fact that such a perceived relationship exists among two or more images, subsequent searches may utilize the perceived association. Thus, by keeping track of the number of times that two or more images are perceived in separate image-seeking sessions to be in some manner related, the system quantifies through the methodology of Dynamic Visual Linking (“DVL”) the closeness of the relationships and uses that information to further facilitate subsequent searches by others. Over time, as the number of entries in the database increases, the quantification of keyword-to-image relationships and image-to-image relationships becomes deeper and more refined, allowing the system to present to subsequent image-seekers only the strongest, most-common relationships. Thus, irrelevant data from untargeted searches and unrelated image viewing is minimized. DVL thereby harnesses the historical efforts of large numbers of image-seekers and makes that historical information available to subsequent image-seekers in a way that relies on the visual components of images. DVL thereby becomes the underlying engine for digital DVL sessions wherein image-seekers step through computer displayed image collections utilizing the previously-established DVL links.

### BRIEF DESCRIPTION OF THE DRAWINGS

FIG. 1 presents a flow chart of a method for locating a goal image of the invention;

FIG. 2A illustrates visual associations between a collection of images of the invention;

FIG. 2B illustrates the weighted visual associations between a collection of images of the invention;

FIG. 3 is a flow chart of a method for establishing associations or links between a collection of images;

FIG. 4 is a flow chart of a method for suggesting images based upon visual associations;

FIG. 5 depicts a prior art client/server computer system with access to a database that may be used with the present invention;

FIG. 6 depicts a prior art client computer of FIG. 5;

FIG. 7 shows a prior art server of FIG. 5 with an internal database;

FIG. 8 illustrates a prior art server of FIG. 5 connected to external data servers;

FIG. 9 depicts a prior art local area network;

FIG. 10 shows prior art access methods for connecting with a web server via the Internet;

FIG. 11 shows a preferred image display format for a digital DVL;

FIG. 12 shows the image display format of FIG. 11 as a page of thumbnail images;

FIG. 13 is a flow chart illustrating a digital DVL session;

FIG. 14 is a flow chart illustrating the use of a keyword to initiate a digital DVL search;

FIG. 15 is a flow chart illustrating a written category/sub-category digital DVL search;

FIG. 16 is a flow chart illustrating the use of a hierarchical path of images to initiate a digital DVL search;

FIG. 17 is a flow chart illustrating the processes subsequent to the end of a digital DVL session;

FIG. 18 illustrates an example tabulation of image-image concurrence values from a sample digital DVL session;

FIG. 19 illustrates a second example tabulation of image-image concurrence values from a sample digital DVL session;

FIG. 20 illustrates a third example tabulation of image-image concurrence values from a sample digital DVL session;

FIG. 21 illustrates the tabulation of concurrence data from two image-image digital DVL sessions;

FIG. 22 illustrates the tabulation of concurrence data from an image-image session merged with cumulative image-image concurrence data;

FIG. 23 illustrates an example tabulation of keyword-image concurrence values from a sample digital DVL session;

FIG. 24 illustrates a second example tabulation of keyword-image concurrence values from a sample digital DVL session;

FIG. 25 illustrates a third example tabulation of keyword-image concurrence values from a sample DVL session;

FIG. 26 illustrates a tabulation of concurrence data from two keyword-image digital DVL sessions;

FIG. 27 illustrates a tabulation of concurrence data from a keyword-image session merged with cumulative keyword-image concurrence data;

FIG. 28 shows some examples of suggested images resulting from the use of various concurrence thresholds and a single launch image during an image-image digital DVL search;

FIG. 29 shows some examples of suggested images resulting from the use of various concurrence thresholds and a launch keyword during an image-image digital DVL search;

FIG. 30 shows some examples of suggested images resulting from the use of various concurrence thresholds, a matching threshold and multiple launch images during an image-image digital DVL search;

### DETAILED DESCRIPTION OF THE INVENTION

Visual Image Linking

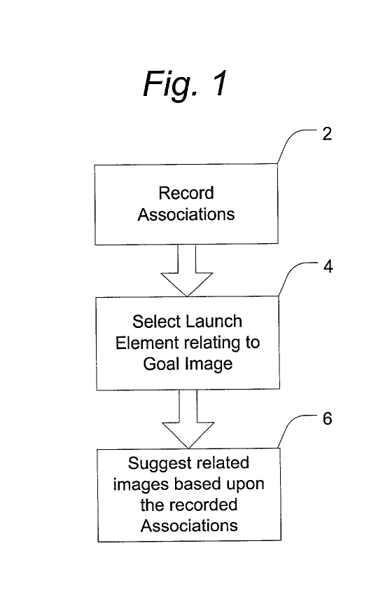

The present invention involves “Dynamic Visual Linking” (“DVL”), which provides a method for organizing and searching within a body of images to locate an image or images of interest without reliance on written descriptions of the contents of the images. To this end and with reference to FIG. 1, images are stored or indexed in some manner to maintain links of visual associations between images without relying on words to describe the basis for the association, step 2. For example, an image A may be linked or associated with image B and image C. The basis for the link or association is some perceived visual relationship from image A to images B and C, but the basis for the association need not be recorded. When a launch image, such as image A, is selected or chosen in step 4, image B and image C may be offered or suggested as possible alternative images due to the presence of the link or association, step 6.

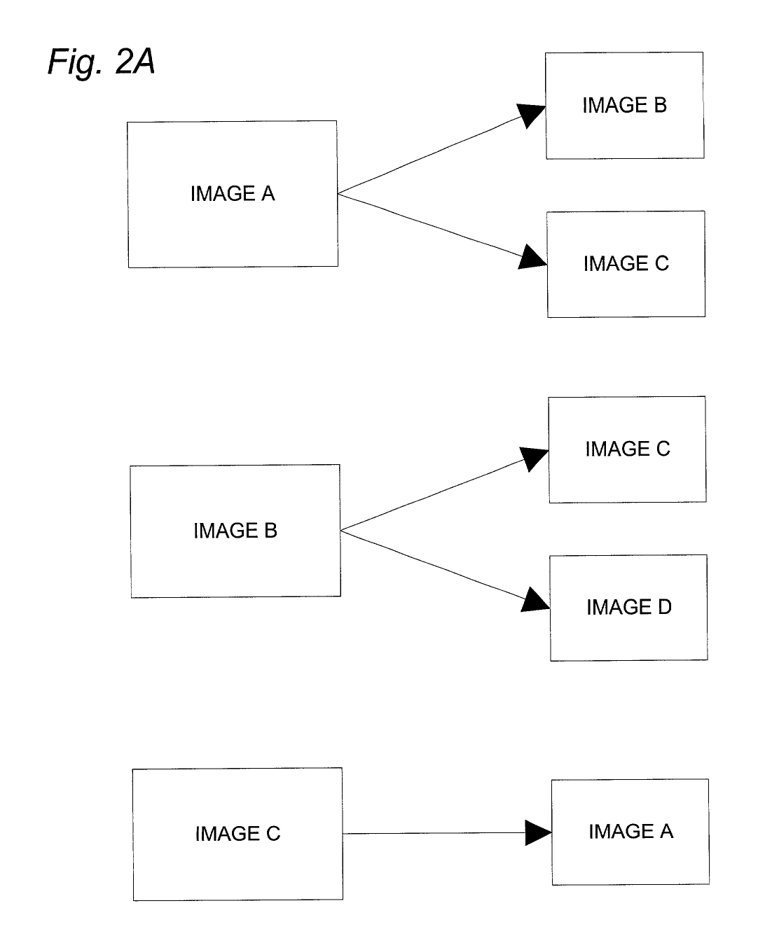

In this system, links between images may be directional. Thus, while image A may be linked to image B, image B may not necessarily be linked to image A. Image B may be linked to other images, for example, image C and image D. However, in the preferred embodiment links are bidirectional. For example, if Image C is linked to image A, image A will be linked to image C. An illustration of these associations is shown in FIG. 2A.

Moreover, in the preferred embodiment, the image links or associations are ranked or weighted. These weights are referred herein as concurrences. The weights or concurrence values seek to quantify the strength of the visual association between images. An illustration of weighted associations is shown in FIG. 2B. In the example, a higher number may be associated with a more likely visual association. Methods for determining such concurrences are described in more detail below.

Preferrably, DVL also includes methods for capturing and storing the associations and weights for a collection of images. This may be accomplished through the arduous task of examining all the images and making visual associations for the image collection and assigning particular weights or concurrences between images. Alternatively, images may be compared by computer using an automated image comparison algorithm. However, in the preferred method, these visual associations and concurrences are dynamically developed by image-seekers during multiple search sessions within the collection as the image-seekers search for some goal image. Since subsequent image-seekers are likely to perceive the same associations or relationships between images, this method provides a powerful means for enhancing the efficiency and efficacy of the process of searching for an image that meets the image-seeker's criteria, and doing so without the use of words.

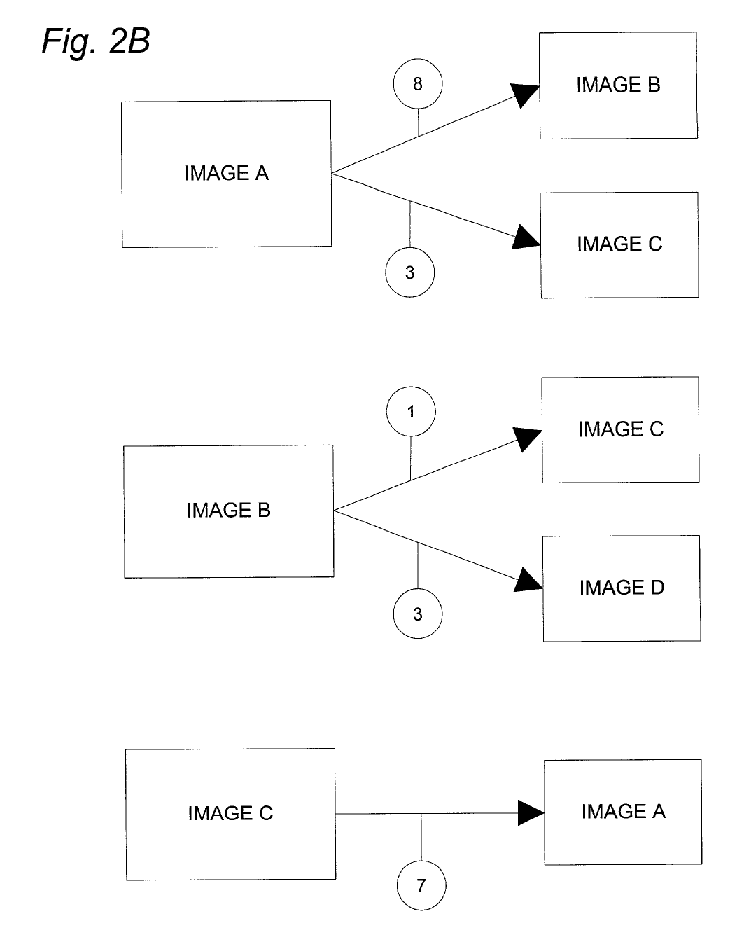

For example, as shown in the flow chart of FIG. 3, each time an image-seeker uses the DVL methodology, a DVL session is initiated, step 30. During the session, DVL image selection data is captured, step 32. Then, after the session has ended, the data that was collected can be used to calculate the concurrences for the keywords and/or images from that session, step 34.

The foundation for the use of image-seekers to establish associations is the concept that when an image-seeker has a goal image in mind, during the process of searching for that image he will consider some of the images as being “interesting” (i.e., containing some element or elements desired in the goal-image). Since the goal image usually remains constant during the course of a search session, all of the images that the image-seeker deems interesting are in some manner related to each other, even though the exact nature of the relationship(s) may not be apparent to an outside observer.

As these perceived relationships are captured and recorded, patterns of associations among images develop over time. By continually capturing and ranking those associations, and then using the associations and rankings, the invention permits an image-seeker to be guided through the universe of images in his attempts to locate his goal-images. Thus, the associations or relationships need not be acquired by means of an independent process, be it analytical or speculative or anywhere in between, nor need the relationships be expressed in words. Instead, the relationships are deduced from the purposeful behavior of image-seekers actually engaged in a search for images and quantified numerically. Moreover, as more data is collected over time, the associations become more focused and reliable. Thus, this data may be used to develop and enhance an existing DVL collection of images.

However, before true DVL searches can be implemented, concurrence data must be generated. This data can be collected in conjunction with image-seekers who are using traditional search methods. For example, an image seeker performing a traditional keyword search uses a keyword to locate images and then shows interest in one or more of the images to which that keyword has been assigned. He may then use another keyword, show interest in one or more of the images to which that keyword has been assigned, and so on. At the end of the session, concurrences can be calculated for all the images in which the image-seeker showed interest, and those values can be posted to the DVL tables. Eventually sufficient concurrence data accumulates for the tables to be used for making image suggestions as part of the DVL methodology.

With regard to the adjustment of associations in step 34, the calculation of concurrence values relates to the actions taken by an image-seeker. In this regard, the minimum requirement for a “concurrence” to occur is for an image-seeker to indicate “interest” in two images in a single session. The value assigned to that concurrence can be based on any desired formula, the simplest of which is to assign a value of 1 to each and every pair of images the image seeker deemed “interesting” during a single session. Thus, for this example, if three images (“i1”-“i2” and “i3”) were found by the imageseeker to be interesting, the image-image pair i1-i2 would receive a concurrence of 1, as would the image-image pairs i1-i3, i2-i3, i2-i1, i3-i1, and i3-i2. Since image-image pairs are bi-directional, concurrence records for the pair i1-i2 are created and concurrence values are accumulated for image-pair i2-i1 as well as for image-pair i1-i2. For preference, the concurrence values for both pairs are identical. By keeping both entries, even if identical, the method speeds later data retrieval, even though it also doubles the size of the concurrence data structure. A more complex version of the methodology may allow these bi-directional concurrence values to vary independently based upon some ordered selection criteria.

Concurrence values may also be calculated for keywords, if keywords are used to launch a DVL search. For example, if a session was launched using keyword “k1” and three images (“i1”“i2” and “i3”) were subsequently found by the image-seeker to be interesting, the keyword-image pair k1-i2 would receive a concurrence of +B+ 1, as would the keyword-image pairs k1-i3 and k2-i3. However, since a keyword launch by definition always begins with a keyword and never with an image, keyword-image pairs are uni-directional. Consequently, only a single association for each keyword-image pair need be created and maintained.

It is preferable to calculate concurrences after the end of a DVL session using a designated formula. When performed, a calculation is done on each and every imageimage combination or keyword-image combination that can be constructed out of the “interesting” images from the entire DVL session. Since the concurrence values are preferably cumulative, the session's concurrence values for each pair would be combined with the concurrence values from prior sessions in accordance with the formula. The simplest, but by no means only, formula is

CV_{C}=CV_{C}+CV_{S}

where CV_{C}=the cumulative concurrency value, and

CV_{S}=the concurrency value for the current session.

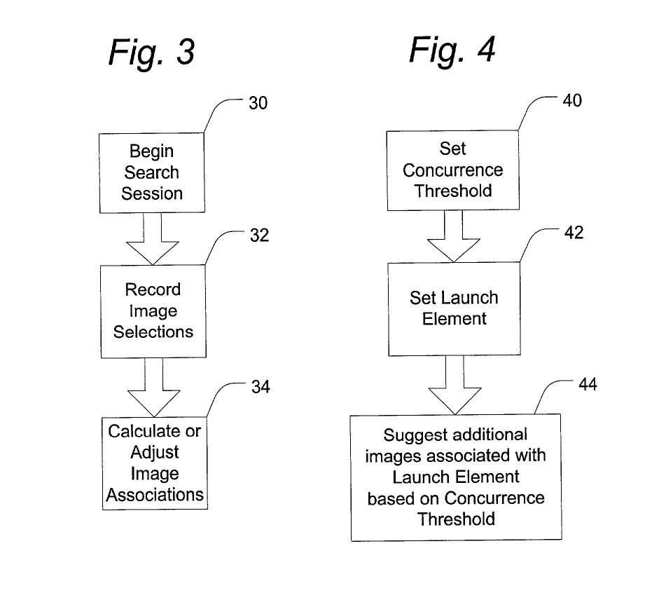

As shown in FIG. 4, the associations and concurrence values can then be used for subsequent sessions by other image-seekers. Upon the selection or assignment of a concurrence threshold, step 40, and the selection of a launch element such as an image or a keyword, step 42, additional images can be presented to the image-seeker, step 44. These images are based upon the links or associations with the related concurrences or weights as compared to or filtered by a concurrence threshold.

With regard to step 42 and the selection of a launch element, also referred to as launch data, all DVL searches must in some manner or other be “launched”, i.e., the DVL search must begin with the image-seeker identifying some image that he perceives as related in some manner to the goal-image. Once the image-seeker has selected the initial “launch” image, DVL draws upon the association or concurrence information to suggest images that have proven over time to be related in some way to the launch image. The image-seeker then reviews the displayed images. If he finds the goal image, then the process is complete, unless he has more than one goal-image in mind. More likely, he will not find the goal image immediately and so will select another image to serve as a new launch image. DVL enables and encourages the image-seeker to move from one visually-related image to another until he either finds the image he seeks or determines that the image does not exist in that particular universe of images.

It is possible for an image-seeker to browse through a random collection of images until he locates one he perceives as incorporating some desirable aspect of his goal-image, which then serves as the initial launch image for the DVL search. However, rather than have the image-seeker begin at a randomly selected image, some means is desirable to provide focus to the search from the outset. Consequently, any preliminary activity that can be employed to expedite the process of locating the initial launch image enhances the efficiency of the search process. Three out of many different possible methods for launching the search are presented here.

1. Keyword-launched: The image-seeker uses a traditional keyword and selects one of the resulting images as the initial launch image. Thus, the images must have previously been associated or indexed by keywords in the traditional manner in order for this launch-method to work. This process is facilitated by calculating DVL concurrence data that relates keywords to images, rather than images to images, so that over time the images that are displayed in response to a keyword launch are those based upon a DVL concurrence threshold.

2. Word-based category launch: The image-seeker steps through word-based layers of categories and subcategories, examining the images contained in those categories and sub-categories until he selects one of the resulting images as the initial launch image.

3. Image-based category launch: The image-seeker steps through hierarchical layers of categories and subcategories represented not by words, but by images. The top-level of categories is presented by a set of images, such as thumbnail images, each of which represents a broad category of images (e.g., sports, nature, travel, etc.). When the image-seeker chooses one of those images, a new set of images is provided, each of which represents a sub-category of the top-level category. Again the image-seeker selects an image, and a new set of images is provided, each of which represents a subsub-category of the top-level category. The process continues to the lowest level of subcategory. When the image-seeker selects an image in that lowest sub-category level, that image serves as the initial launch image.

As a practical matter, all three methods (as well as others) can be employed at different times in the same DVL session to launch a DVL search, and the methods can be interspersed, as well. For example, an image-seeker can employ a word-based category launch and then, prior to locating the goal-image, decide to switch to a keyword-launched search.

With regard to step 44 and the suggestion of associated images, while these images may be suggested without regard to any weighting or concurrence value, the preferred method includes an evaluation of the concurrence value to determine whether the image should be displayed. For example, once the image-seeker selects the initial launch image, he may be presented with those images that show the highest concurrence values relative to that image. Similarly, the images he views thereafter are those that show the highest concurrence values relative to the subsequent launch images. However, the data contained in the cumulative DVL concurrence tables can be used in a variety of ways to control which images will be displayed to an image-seeker when a DVL search is launched. These methods include, for example, the following.

1. In the simplest suggestion methodology, all image pairs that include the launch image are ranked by concurrence value, and all those having a concurrence greater than a designated threshold value are suggested.

2. The images to be suggested can be refined by keeping track of which images were previously used as launch images in the current session and using them for a “group launch.” Thus, if the image-seeker seeker uses i1 as a launch image followed by i2 as the next launch image, the images suggested could be limited to those images that have concurrences above a designated threshold value for both images (i1 and i2) in the launch group; i.e., the only images suggested would be those that have a concurrence above the threshold level not only for i2, but for i1 as well.

3. In a refinement similar to number 2 above, the image-seeker is permitted to designate multiple images himself to use for a group launch, rather than having the group constructed in subsequent DVL searches.

4. In a further refinement of the group launch in number 3 above, the imageseeker is given the ability to control the degree of the refinement by being permitted to designate the number of images in the group that should be used to determine if an image is sufficiently related to the group to be included as a suggestion. For example, if the image-seeker assigns five images to the group but specifies a group threshold of three, then any given image is included if and only if it has a sufficiently-high concurrence value for any three of the five images in the launch group.

B. Computerized Dynamic Visual Linking

As previously described, the DVL invention permits a person seeking an image (the “image-seeker”) to efficiently and effectively view the images contained in a large collection of images in a manner that relies almost exclusively on visual techniques and uses previously collected data to optimize the likelihood that the image-seeker will locate the desired image (the “goal image”) if it exists in the collection. While the method may be automated and wholly implemented on a single device or computer with a processor, memory, and input/output devices, with the advent of global networking, such as the internet, and the vast number of users worldwide, the potential of the DVL methodology may be more fully realized through the use of such networks. To this end, the following disclosure presents such a networked system using DVL.

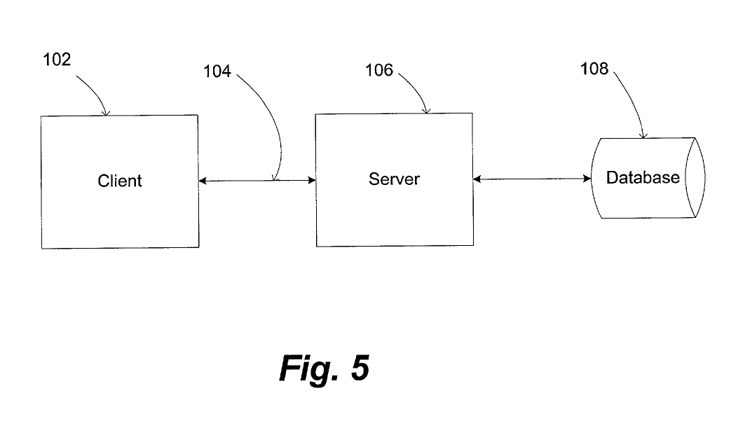

Referring to FIG. 5, a typical, simple computer network consists of a client device 102 (a pc, a Mac, etc.) linked to a server device 106 by some type of connection 104. The server device 106 includes some mechanism for storing data 108, such as a magnetic disc or an optical disc. Any mechanism that permits the exchange of data between the client device 102 and the server device 106 constitutes the connection 104. The connection might utilize wire or optic lines, as in an Ethernet network connection or in a typical connection over the Internet, or it might be wireless, as when a satellite is used as part of the connection.

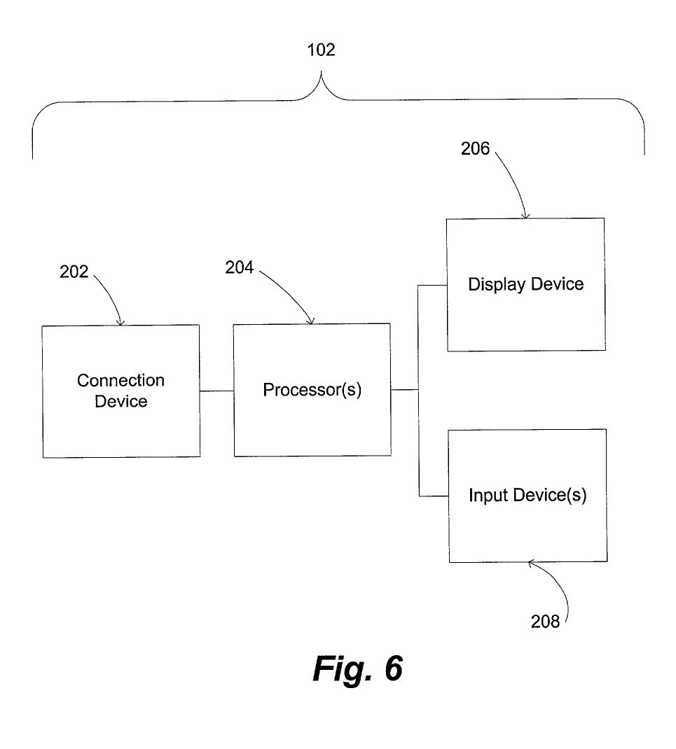

The client device 102, shown in FIG. 6, typically comprises a device or devices used to display data 206, such as a computer monitor, as well as input devices 208, such as a keyboard, a computer mouse or a microphone. The client device 102 would contain its own central processing unit (CPU) 204 and memory unless it is a “dumb” terminal. Except in the case of a dumb terminal, the client runs a computer program, such as a browser, that controls the internal processing of data as well as the movement of data between the client 102 and the server 106. The client device 102 typically uses a connection device 202, such as a network card, a modem, or a wireless adapter to provide an interface to the connection medium.

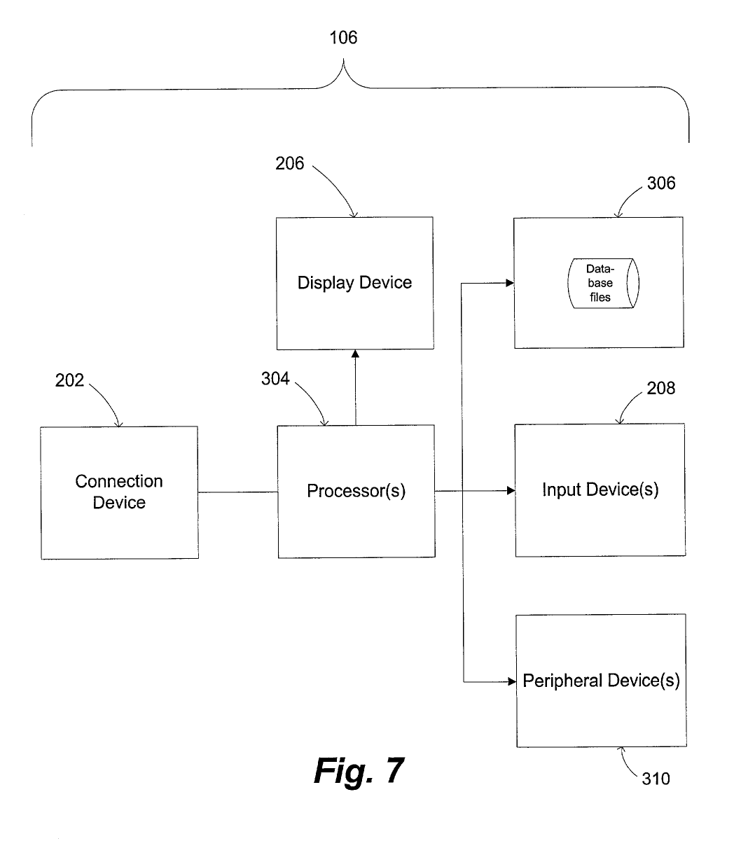

A simple server device 106, shown in FIG. 7, may have a display device 204 such as a computer monitor, as well as input devices 208, such as a keyboard, a computer mouse or a microphone and one or more processors 304 with memory and may also have access to a database 306. The server device 106 uses a connection device 202, such as a network card, a modem, or a wireless adapter, to provide an interface to the connection medium. The server 106 runs appropriate software such as Internet Information Server or Apache or other similar software to implement the communication.

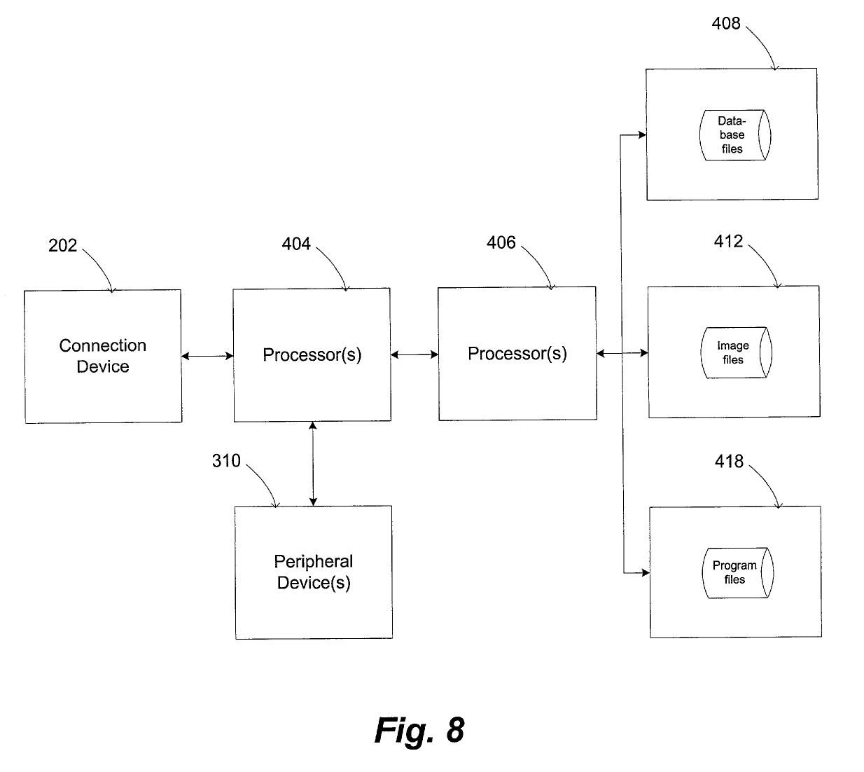

As shown in FIG. 8, multiple server devices 106 might be configured together for any number of reasons. Some of these reasons include (1) to distribute the workload among multiple separate servers and optimize the efficiency of operation of individual servers by limiting the number of tasks they must perform simultaneously, and (2) to provide redundancy in the event of server failure. It is not unusual to configure dualprocessor servers together 404, 406. Nor is it unusual to store data on separate, dedicated servers such as a database server 408, an image server 412, or a program server 418, or to configure in peripheral devices 310 such as printers and scanners.

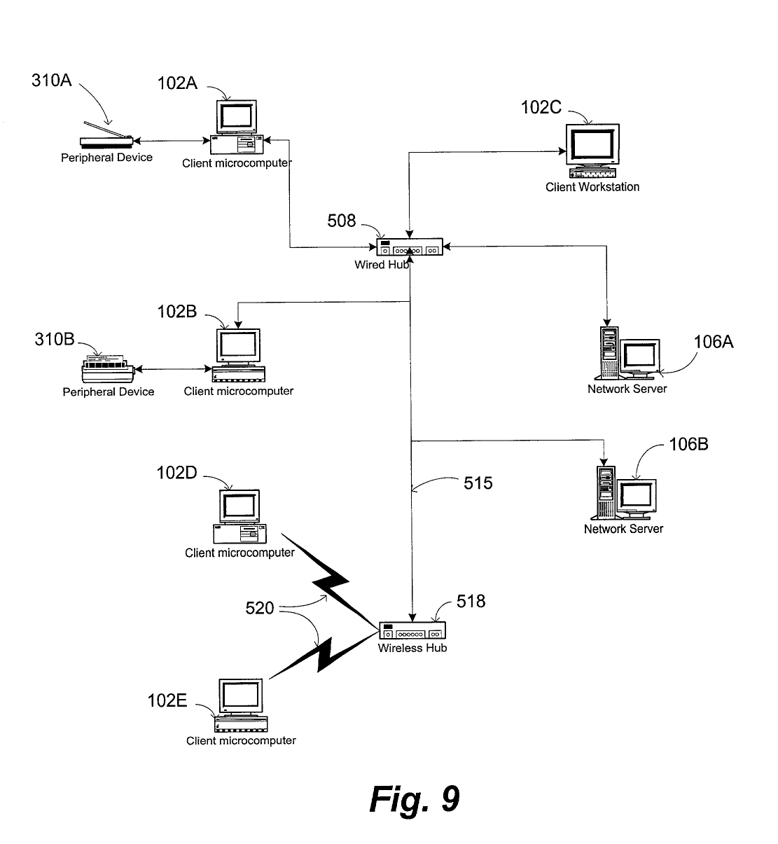

A typical self-contained network, shown in FIG. 9, might comprise a collection of different clients 102A, 102B, 102C, network servers 106A, 106B and peripheral devices 310A, 310B interconnected using Ethernet cable 515 by means of a network hub 508. The network could also incorporate wireless client devices 102D, 102E that use wireless signals 520 to exchange data with a wireless hub 518, which is in turn connected via Ethernet cable 515 to the wired network.

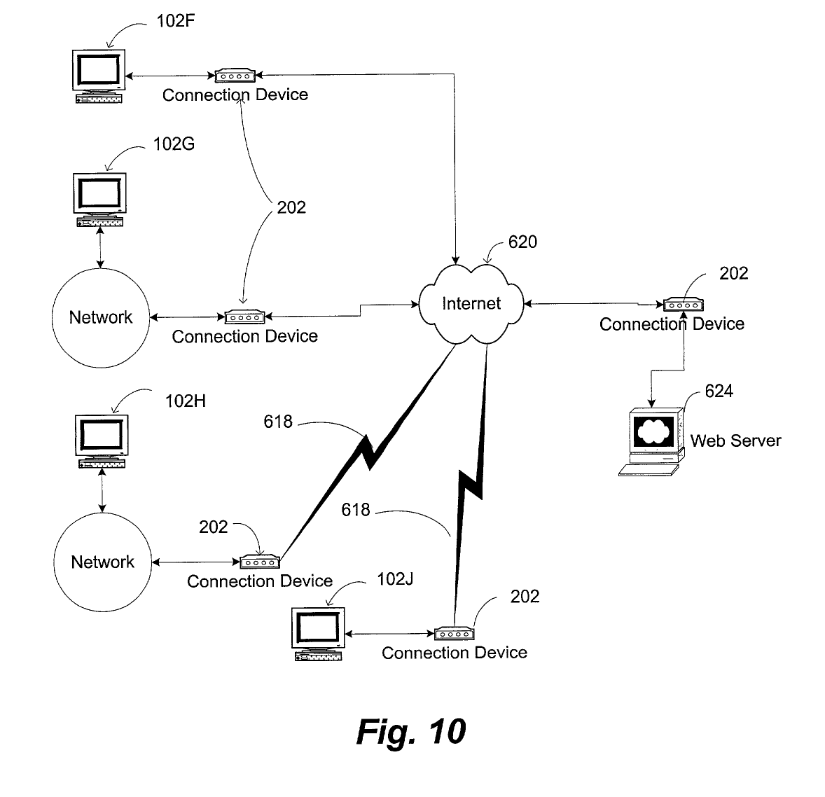

The image repository as well as the programs and servers that control access to the images may be located within a self-contained single local area network or on a collection of local area networks conjoined into a wide area network. Alternatively, as shown in FIG. 10, the images and programs to access them can be located on a web server 624 or servers accessed via the Internet 620 or other public network. When the Internet is used in this manner, the images can be accessed by any client device 102F, 102G, 102H, 102J with access to the Internet 620.

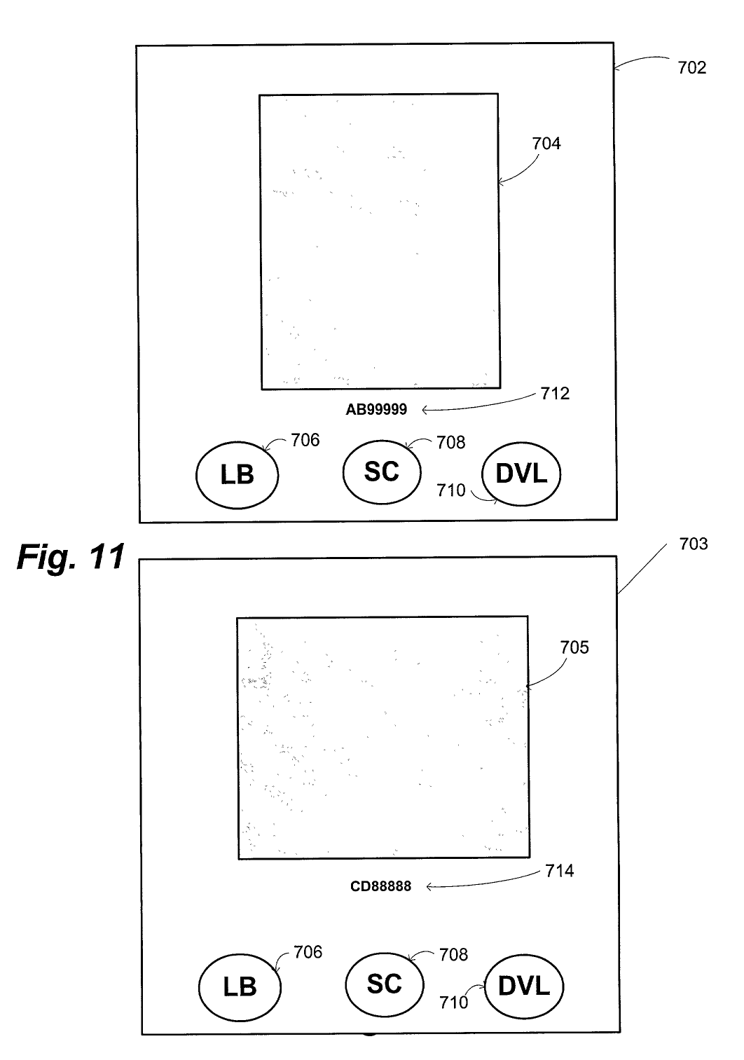

Many different display formats may be used to present images across the network for the DVL search. However, it is preferred to utilize displays which mimic the traditional devices of the stock photography industry. To this end, the image-seeker preferably reviews the results of a search for a launch image where the images are made to mimic the appearance of 35mm color slides in frames. Examples of such 35 mm film frames are shown in FIG. 11. Whether the image or photograph is oriented in the vertical mount 704 or the horizontal mount 705, the size and shape of the frames 702, 703 are the same in both cases. In these virtual frames, if the image-seeker points his computer mouse anywhere within the image mounts 704, 705, the image expands to a larger size so that it can be viewed in more detail. Mouse-sensitive buttons appear along the bottom edge of the frames. These buttons, when clicked on by a computer mouse, cause certain actions to occur. Button LB 706 causes a copy of the image to be set aside in a “lightbox” where it can be viewed again at a later time, button SC 708 causes a copy of the image to be sent to the image-seeker's “shopping cart”from which it can later be purchased, and button DVL 710 causes the image to serve as the launch image for a new DVL search, which utilizes the DVL methodology. By clicking on image mounts 704, 705 or by clicking on one of the three buttons 706, 708, 710, the imageseeker demonstrates interest in the image and the image number 712, 714, is captured, to be used later for calculating concurrence data. To this end, any method for capturing data can be used, for example, by an analysis of server log files. Another method is to monitor the image-seeker's activities on the server in real-time and use programming to cause the relevant data to be saved to tables or other appropriate data structure for subsequent analysis.

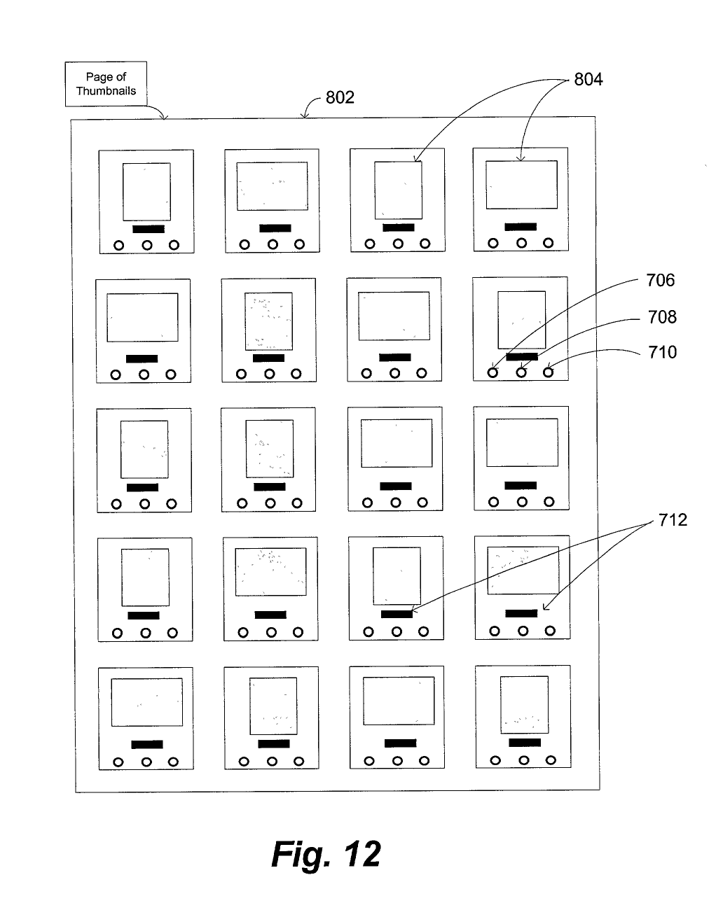

Similarly, with regard to displays of multiple images, pages of thumbnail images 802, as presented on a computer screen illustration of FIG. 12, mimic the appearance of clear vinyl sheets holding multiple rows and columns of mounted 35 mm color slides. The number of rows and columns might vary, but each individual thumbnail image 804 can be enlarged for closer viewing by clicking on the image itself. Alternatively, by clicking button LB 706 the image can be set aside in a lightbox, by clicking button SC 708 the image can be sent to the image-seeker's shopping cart, or by clicking button DVL 710 the image can serve as the launch image for a new DVL search.

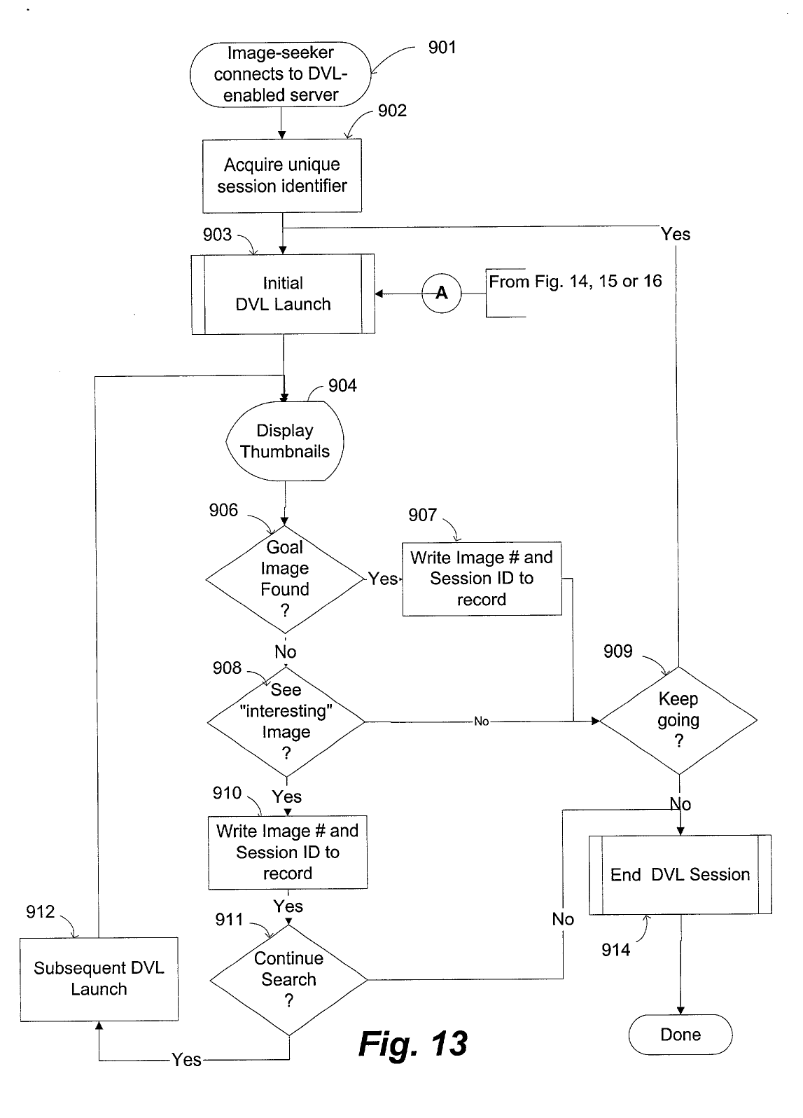

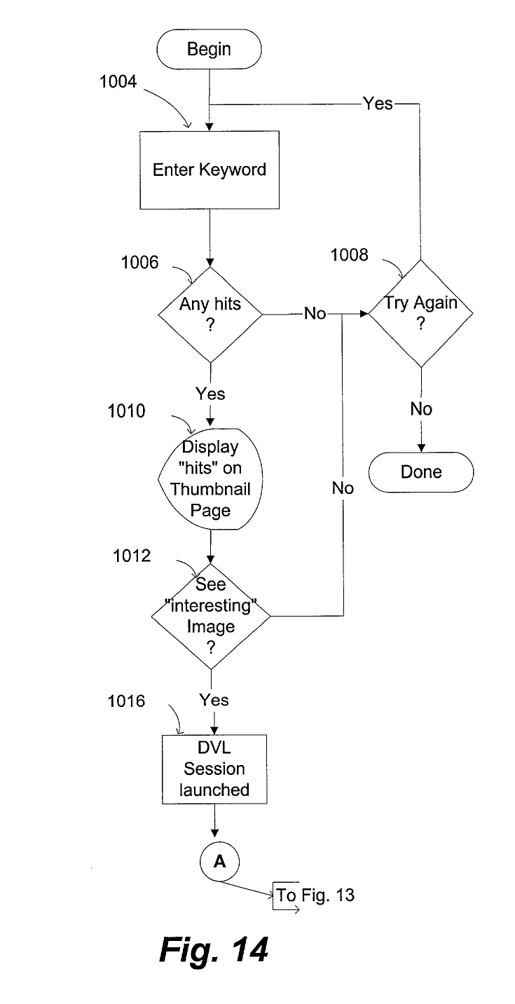

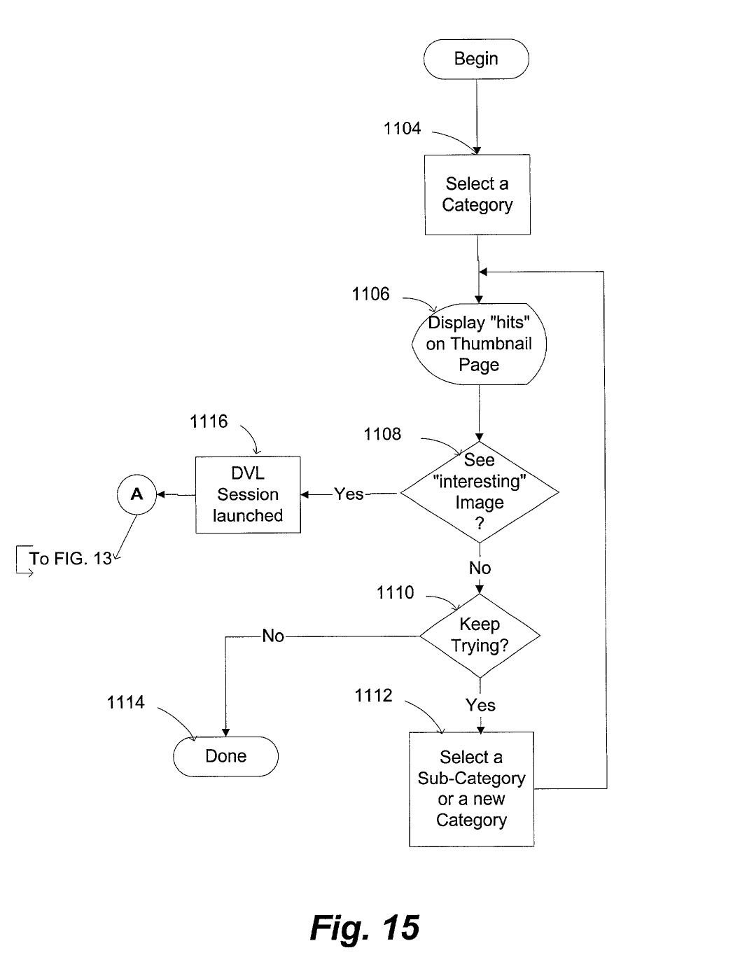

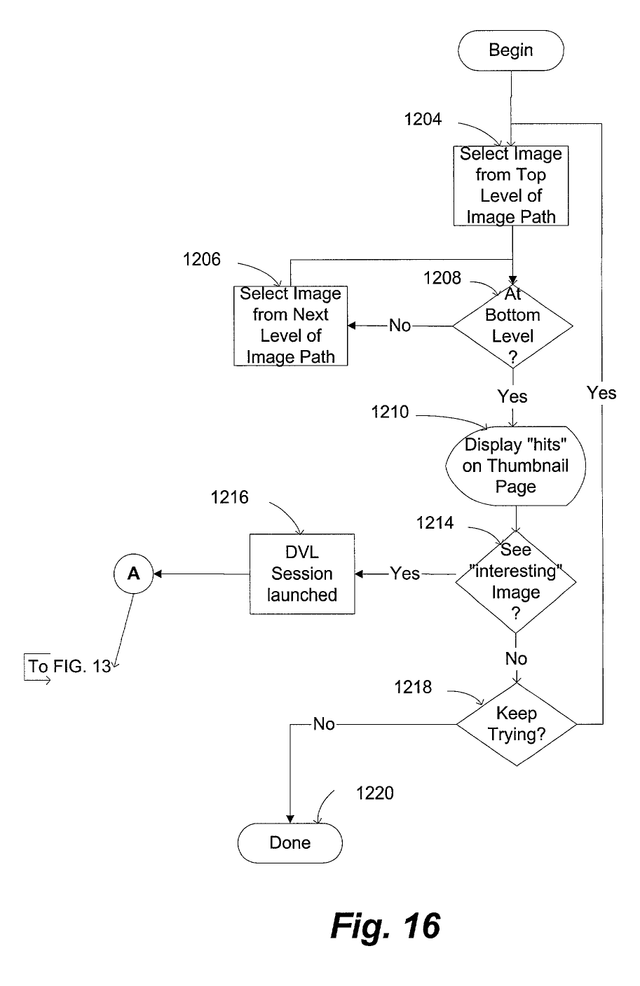

Referring to the flow chart of FIG. 13, a DVL session, commences when an image seeker initiates a new session by connecting to the server, step 901. A unique session identifier is acquired in step 902, after which the image-seeker selects an image for the initial DVL launch in step 903 (from FIG. 14, FIG. 15, or FIG. 16). The identifier, known as a sessionlD on web-based systems, remains constant until the image-seeker disconnects from the server or remains inactive for an amount of time that exceeds a defined threshold. The session identifier is stored to keep track of the particular imageseeker along with all image selection data.

The initial launch results in the suggestion or display of thumbnail images, step 904, each in a frame 702, 704 as shown in FIG. 12 on a thumbnail page 802 or pages. If the goal-image is found, step 906, its image number and session identifier are saved, step 907, for use later in calculating concurrences. If no more images are required, step 909, the session ends in step 914. Otherwise, the image-seeker can commence a new DVL search by returning to step 903. If no goal-image has been found at step 906 but the image-seeker sees or indicates that one of the images is “interesting,” the session identifier and the image number are saved in step 910. If the image-seeker wishes to continue the search in step 911, he initiates a new DVL search by clicking on a new launch image in step 912, otherwise, the session ends, step 914. If the image-seeker indicates “interest” in an image in step 908, DVL data is recorded, step 910, and a new DVL launch in step 912 takes place. The cycle is repeated until the image-seeker finds his goal image or images, or determines that he will not find the goal image he is seeking and has no other goal images to find. At this time (or at a later time), the DVL session-end processes run, step 914, resulting in new concurrence data being added to permanent DVL tables.

A keyword-launch of a DVL session, shown in the flow chart of FIG. 14, begins when the image-seeker submits a keyword in step 1004. A search is made of the table in which keywords have been previously stored. If the search returns no “hits,” step 1006, (each image found to have that keyword assigned being referred to as a “hit”), the image seeker can either abandon the search entirely in step 1014 or if he wishes to continue, step 1008, he can submit a new keyword in step 1004. If one or more hits does occur, the associated image(s) is (are) displayed on one or more thumbnail pages in step 1010. If the image-seeker sees no images of interest, he can either abandon the search entirely, step 1014, or submit a new keyword in step 1004. On the other hand, if he finds any image to be of interest, step 1012, his DVL session has been launched, step 1016, and the DVL process continues at point A in FIG. 13.

A category-launch of a DVL session is illustrated in the flow chart of FIG. 15. This launch begins when the image-seeker selects (clicks on) a category of images to view as depicted in step 1104. In response, a page or pages of thumbnails are displayed, step 1106. If the image-seeker sees no interesting images, step 1108, then he can abandon the search entirely, step 1114, or if he wishes to continue, step 1110, he can select either a sub-category to view or an entirely new category, step 1112. At whatever point he finds an image to be of interest, step 1108, his DVL session has been launched, step 1116, and the DVL process continues at point A in FIG. 13.

The flow chart of FIG. 16 portrays an image-based category launch of a DVL session begins when the image-seeker selects (clicks on) an image at the top level of the category hierarchy, step 1204. This causes a display of thumbnail images, each of which represents a subcategory of the top-level category. The image-seeker continues selecting images from each succeeding level of the hierarchy, step 1206, until he has selected an image from the very lowest level, step 1208, at which point he is presented with a display of thumbnails that previous DVL searches have shown to be related to the image he selected, step 1210. If the image-seeker sees no interesting images, step 1214, then he can abandon the search entirely, step 1220, or if he wishes to continue, step 1218, he can return to the top-level, step 1204, and try again. At whatever point he finds an image to be of interest, step 1214, his DVL session has been launched, step 1216, and the DVL process continues at point A in FIG. 13.

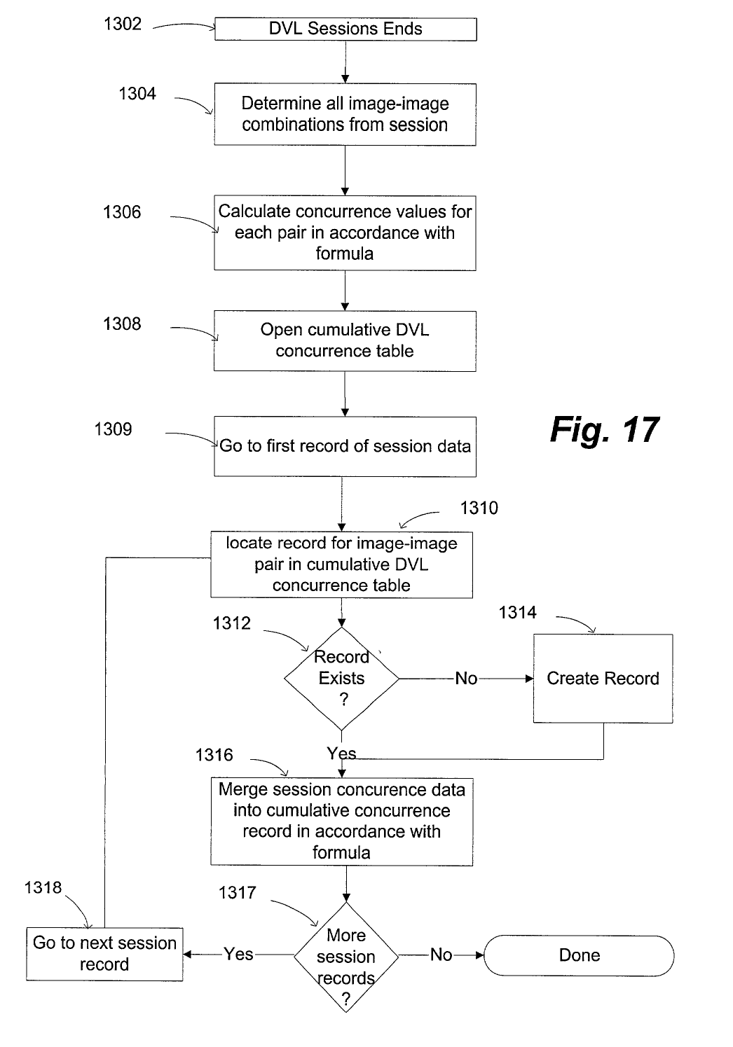

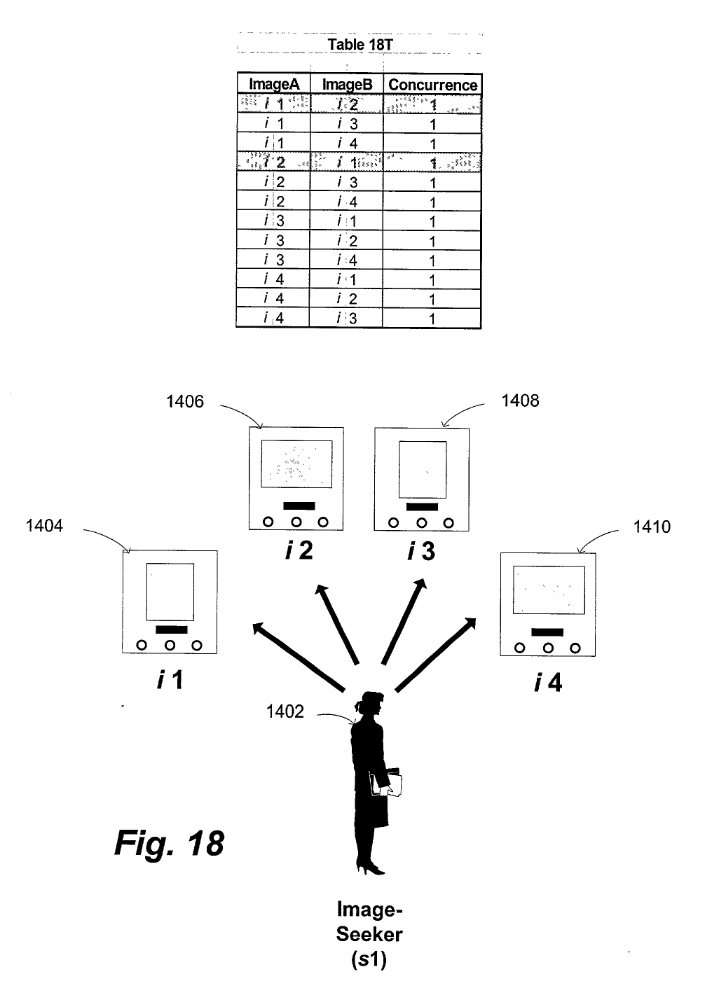

FIG. 17 shows a flow chart of the processes for calculating concurrence values. Calculating concurrence values for a session and subsequently posting them to the cumulative DVL concurrence tables takes place sometime after the session ends. Once the session is complete, step 1302, the images from that session in which the imageseeker showed “interest” are determined, step 1304, and an entry for each added to a table that associates each image-image pair and keyword-image pair with the session and then these values are combined with a cumulative table, steps 1306 through 1316. These processes are illustrated in more detail in FIGS. 18 through 30.

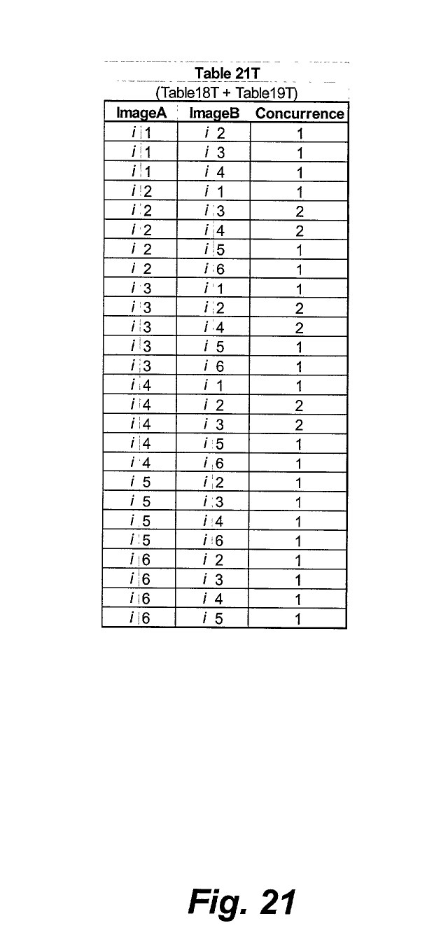

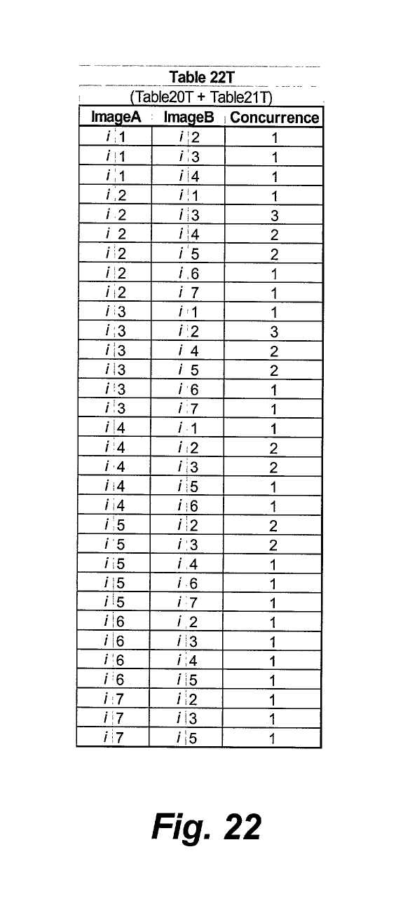

Examples of the calculation of DVL concurrence values for a DVL session are depicted in FIGS. 18 through 20 with the resulting table of associations and concurrences for each session in tables 18T, 19T and 20T respectively. These tables are progressively combined into tables 21T which appears at FIG. 21 and table 22T of FIG. 22. Essentially, the tables contain all image-image combinations of the images the image-seeker has found “interesting” and are given a concurrence value calculated according to the preferred formula.

In FIG. 18 an image-seeker (S1) 1402 has shown interest in four images designated as i1 1404, i2 1406, i3 1408, and i4 1410. In table 18T, all 12 possible bidirectional image-image combinations of those images are assigned a concurrence value of 1. Image-image pairs are bi-directional in that each image-image pair is represented twice in the table.

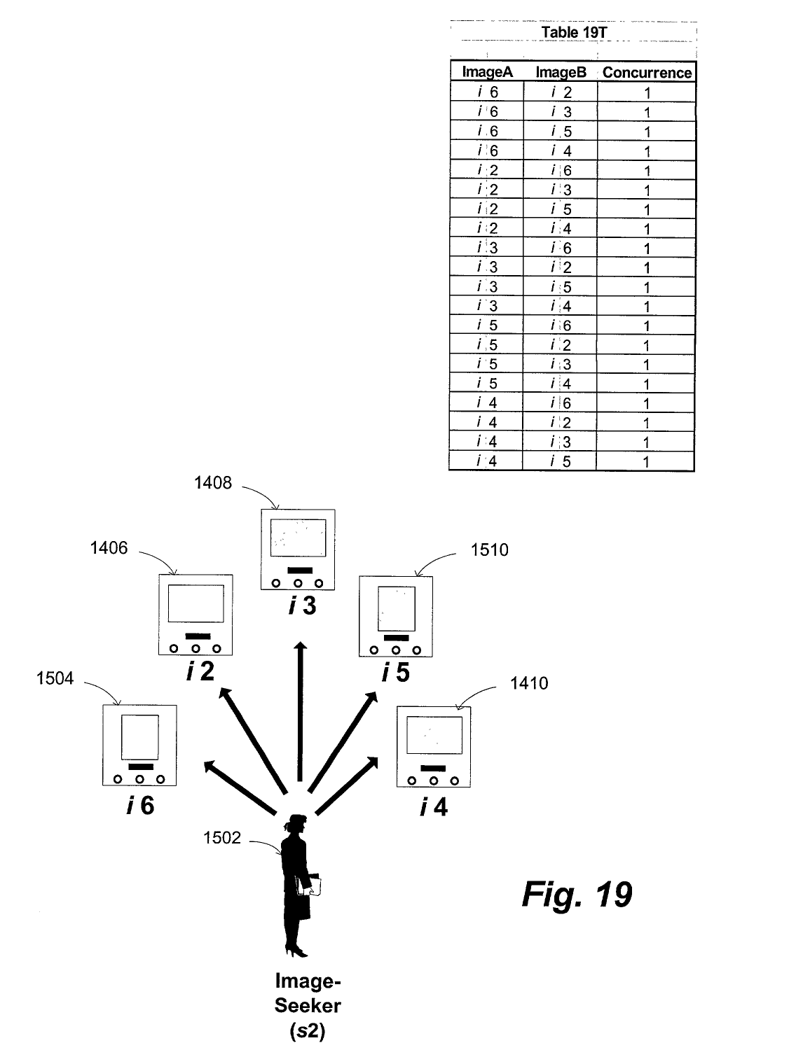

In FIG. 19 image-seeker (S2) 1502 has shown interest in five images designated i6 1504, i2 1406, i3 1408, i5 1506 and i4 1410. In table 19T, all 20 possible image-image combinations of those images have a calculated concurrence value of 1.

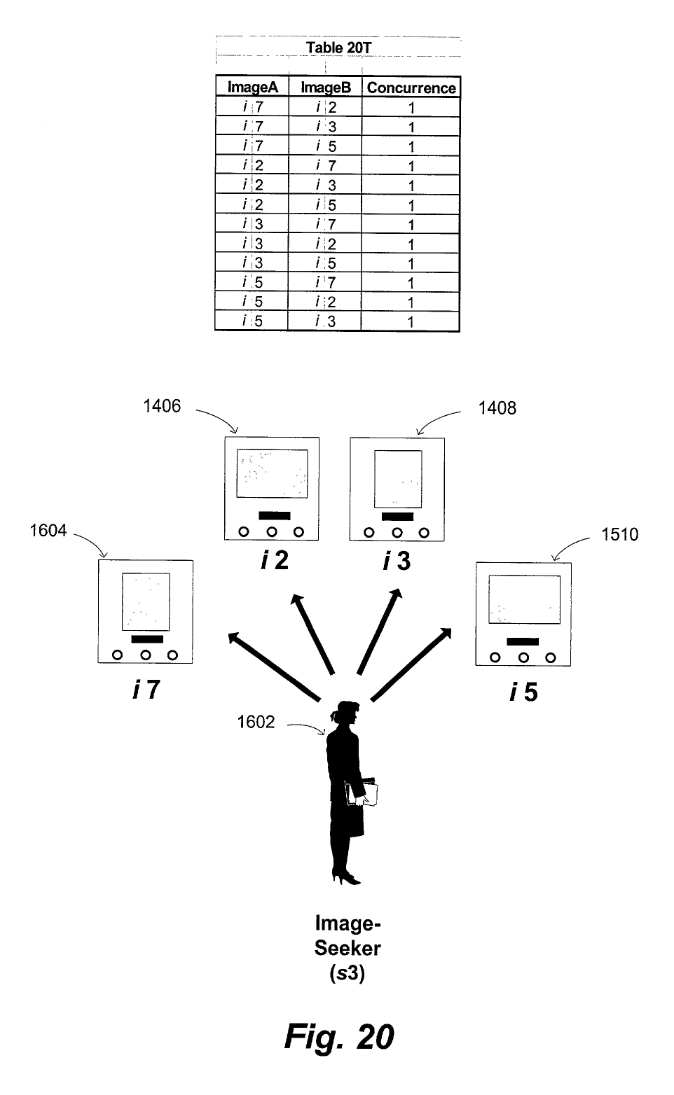

In FIG. 20 image-seeker (S3) 1602 has shown interest in four images, 1606, 1608, 1610, designated as i71604, i2 1406, i3 1408, and i5 1506, respectively. In table 20T, all 12 possible image-image combinations of those images have a calculated concurrence value of 1.

In FIG. 21, table 21T combines the entries from tables 18T and 19T. In this regard, one and only one entry exists for each image-image pair that exists in either Table 18T or Table 19T. Where an image-image pair exists in both table 18T and table 19T, the concurrence values have been combined in accordance with the formula by summing them. Similarly, tables 22T and 20T are combined into table 22T of FIG. 22. Thus, if all image-image concurrency data from all future DVL sessions were to be merged in like manner into table 22T, it would serve as the cumulative DVL concurrency table for image-image pairs.

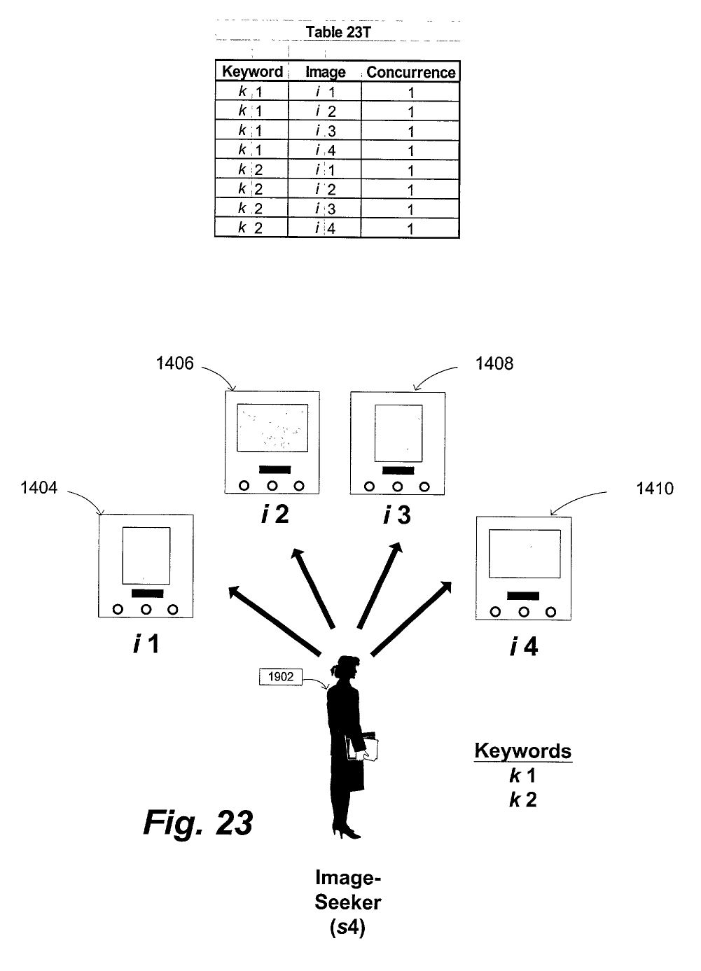

This process is also seen in the FIGS. 23 through 27, except that only the capturing of keyword-image pairs is illustrated rather than image-image pairs. To this end, in FIG. 23, an image-seeker (S4) 1902 has launched DVL searches using keywords k1 and k2 and has shown interest during the session in four images designated as i1 1404, i2 1406, i3 1408, and i4 1410. In table 23T, all 8 possible keyword-image combinations have a calculated concurrence value of 1. Because keyword-image pairs are uni-directional, each keyword-image pair is represented only once in the table.

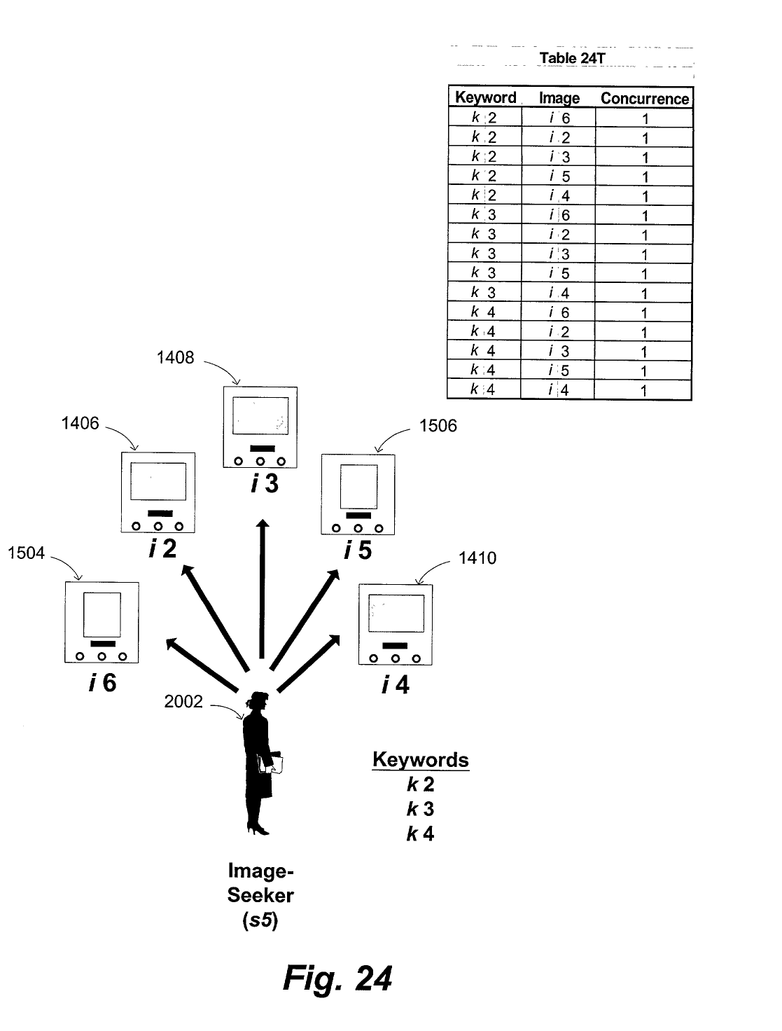

In FIG. 24 an image-seeker (S5) 2002 has shown interest in five images designated as i6 1504, i2 1406, i3 1408, i5 1506 and i4 1410. In table 24T, all 15 possible keyword-image combinations have a calculated concurrence value of 1.

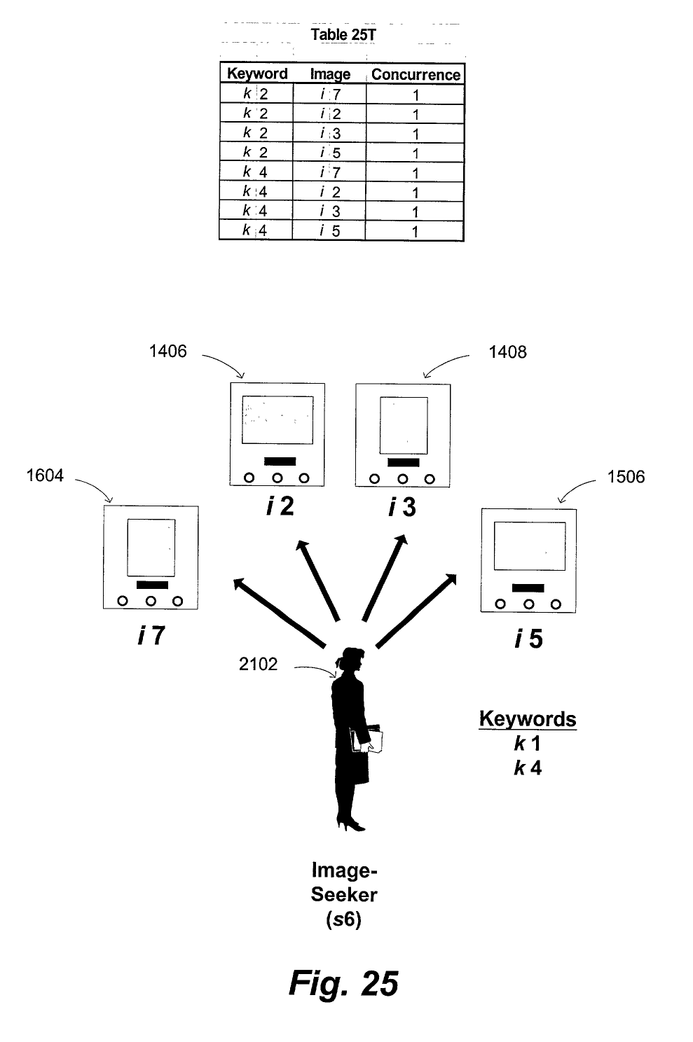

In FIG. 25 an image-seeker (S6) 2102 has shown interest in four images designated as i71604, i2 1406, i3 1408, and i5 1506. In table 25T, all 8 possible keyword-image combinations have a calculated concurrence value of 1.

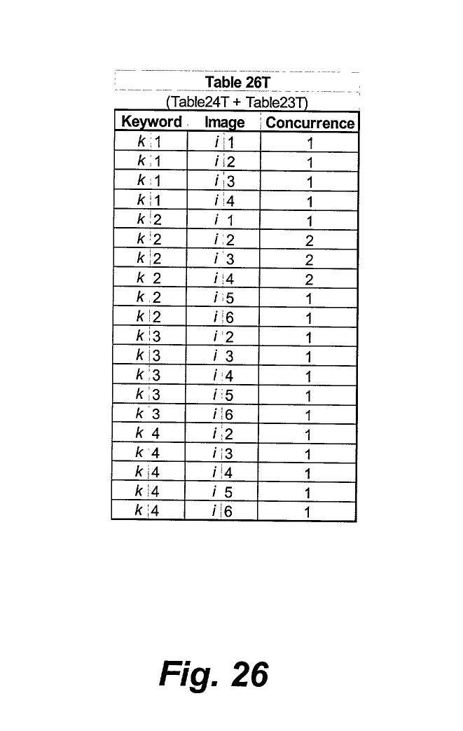

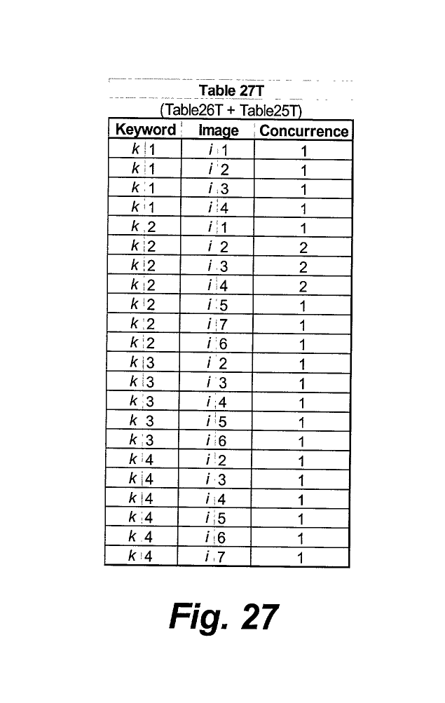

As shown in FIG. 26, in table 9 combines the entries of tables 23T and 24T with one entry for each keyword-image pair that exists in either table 23T or table 24T. Where an image-image pair exists in both tables 23T and 24T, the concurrence values have been combined in accordance with the chosen formula by summing them. Similarly, in FIG. 27, table 25T, a concurrence table for a single session, is merged into table 26T, a table that was formed by merging keyword-image concurrency tables together, to produce table 27T. Thus, if all keyword-image concurrency data from all future DVL sessions were to be merged in like manner into table 27T, it would serve as the cumulative DVL concurrency table for keyword-image pairs.

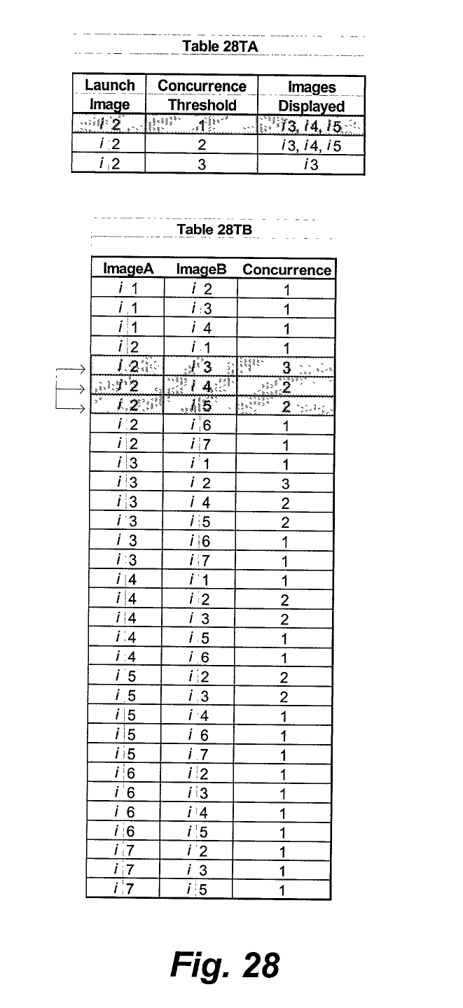

In FIGS. 28, 29 and 30, tables are use to illustrate the process of suggestion or displaying associated images in response to either a launch image, a launch keyword or a group of launch images. For example, in FIG. 28, table 28TA illustrates suggested images for a single launch image using the concurrency values of table 28TB. This example is based upon the rule that the specific images displayed to the image-seeker in response to a launch image must have a concurrence value greater than or equal to the designated concurrence threshold value, shown in table 28TA, which can be set to any desired level. Thus, table 28TA demonstrates that for a concurrence threshold of 1, images i3, i4, and 15 will be displayed for launch image i2. If the threshold is raised to 3, only image i3 meets or exceeds the threshold, and is therefore the only image displayed.

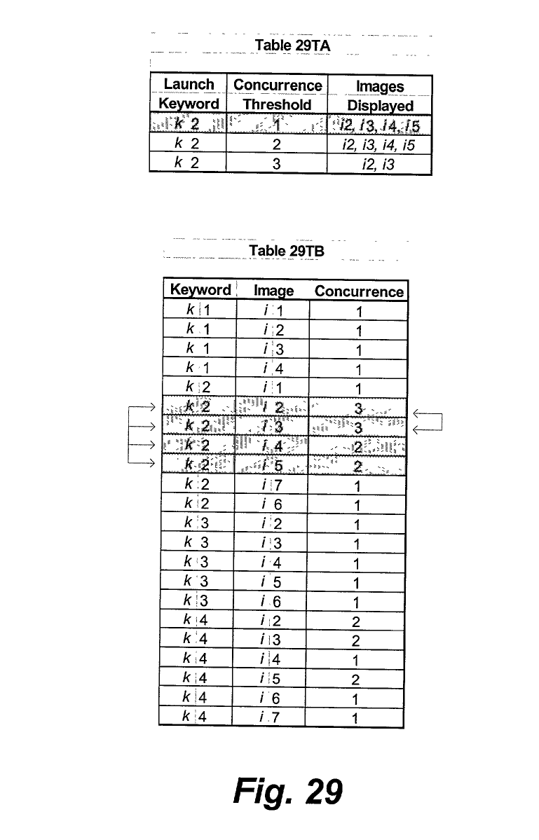

In FIG. 29, table 29TA illustrates suggested images for a particular launch keyword using the concurrency values of table 29TB. In this example, the specific images displayed to the image-seeker in response to a launch keyword must be greater than or equal to the designated concurrence threshold value, which can be set to any desired level. Thus, table 29TA demonstrates that at a concurrence threshold of 1, images i2, i3, i4, and i5 will be displayed. If the threshold is raised to 3, only images i2 and i3 meet or exceed the threshold, and are therefore the only images displayed.

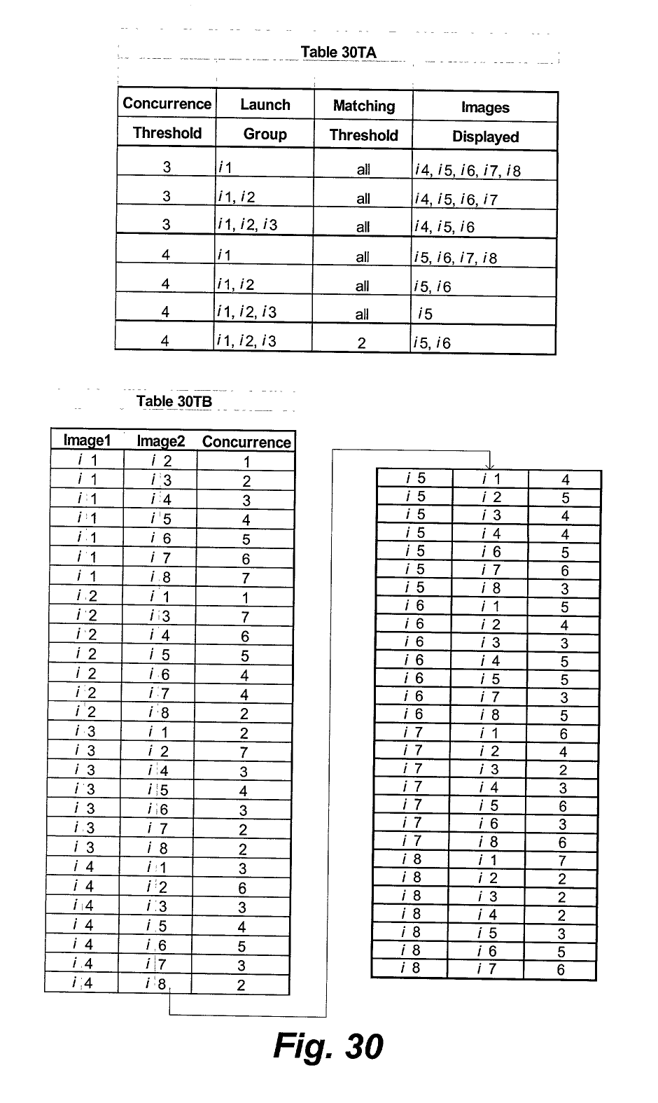

In FIG. 30, table 30TA illustrates suggested images for a group of launch images using the concurrency values of table 30TB. In this example, a matching-threshold, in addition to the concurrence threshold is used to affect the images that are displayed. The matching threshold indicates the number of launch images that an potential image must be associated with at the designated concurrence threshold to be included in the suggestion or display. Therefore, when the matching threshold is “all”, in order to be included in the display, an image must meet the designated concurrence threshold for all images contained in the launch group. Referring to table 30TA, when the launch group consists of only the single image i1, images i4, i5, i6, i7, and i8 all meet the criteria of a concurrence-threshold of 3 and are included in the display. By adding image i2 to the launch group, each image included in the output display must now meet a concurrence threshold of 3 for both i1 and i2. In this case, i8 no longer meets the criteria. Similarly, when i3 is added to the group, i7 no longer qualifies. By increasing the threshold to 4 changes for the suggested or displayed images will result because not all previously included images can meet the higher threshold. Thus, only a single image i5, meets the higher concurrence threshold when the matching-threshold is set to “all” and i1, i2 and i3 make up the launch group. However, for this example, when the matching-threshold is changed to “2,” meaning 2 out of 3, image i6 then meets the less-stringent criteria and is included.

Although the invention has been described with reference to particular embodiments, it is to be understood that these embodiments are merely illustrative of the application of the principles of the invention. Numerous modifications may be made in the illustrative embodiments of the invention and other arrangements may be devised without departing from the spirit and scope of the invention.

I claim,

1. A database of photographs or pictures for a stock photography agency or the like comprising:
a plurality of ditigized images; and
a table of associations between images to facilitate accessing said images,
wherein said associations are assigned as a result of selections of said images by users of said database during searches for goal images within said database.

2. The database of claim 1 wherein said table represents non-verbal associations.

3. The database of claim 1 wherein said associations are non-verbal links between images.

4. The database of claim 1 wherein said table represents image pairs.

5. The database of claim 4 wherein said table further contains a weight for each image pair.

6. The database of claim 5 wherein said weight is a concurrence value.

7. A method for searching in a database of images comprising the steps of:
selecting at least one launch image that is related to a goal image;
using said launch image for accessing a table in said database that contains non-verbal associations between images of said database; and
displaying an image from said database that shares a non-verbal association with said launch image;
wherein said associations are recorded in said table based upon paired selections made by image seekers who previously used said database.

8. The method of claim 7 wherein said non-verbal associations relate image pairs.

9. The method of claim 7 wherein said step of displaying an image is based upon an analysis of a concurrence value stored in said table that is related to the shared non-verbal association between the displayed image and said launch image.

10. The method of claim 9 wherein said concurrence value is calculated from image selections made by image seekers who previously used said database.

11. The method of claim 10 wherein said analysis is a comparison between said concurrence value and a threshold value.

12. The method of claim 11 wherein said step of displaying an image is based upon an analysis of a matching threshold for a group of launch images.

13. The method of claim 11 wherein said comparison determines whether the concurrence value equals or exceeds the threshold value.

14. A computerized apparatus for locating an image from a collection of images comprising:
a computer; and
a database having digitized images and a table containing numerical associations between said images;
wherein said computer:
(a) prompts for the input of launch data pertaining to said goal image, and
(b) locates a related image where said related image shares a numerical association with said launch data in said table.

15. The computerized apparatus of claim 14 wherein said numerical associations between images are relations between image pairs.

16. The computerized apparatus of claim 14 wherein said computer records numerical associations between images of said database in said table where said numerical associations are based upon inputs provided during a search of said database that indicates interest in said images.

17. The computerized apparatus of claim 14 wherein said computer records keyword-to-image associations where said keyword-to-image associations are based upon inputs provided during a search of said database that indicates interest in said images.

18. The computerized apparatus of claim 14 wherein said launch data represents an image.

19. The computerized apparatus of claim 14 wherein said launch data represents a group of images.

20. The computerized apparatus of claim 19 wherein said computer's step of locating a related image is contingent upon a matching threshold and said numerical associations of said table.

21. The computerized apparatus of claim 14 wherein said computer's step of locating a related image is contingent upon said numerical association satisfying a threshold value.

22. The computerized system of claim 21 wherein said numerical association comprises a concurrence value.

23. A computer readable medium with executable instructions for controlling the search of a database of images, said instructions controlling:
recording of non-verbal associations between images of said database in a searchable data structure;
prompting for input of launch data;
locating said launch data in said data structure; and
accessing at least one image in said database where said image shares a non-verbal association in said data structure with said launch data.

24. The computer readable medium of claim 23 wherein said non-verbal associations between images are pairs of images.

25. The computer readable medium of claim 24 wherein said data structure is a table.

26. The computer readable medium of claim 23 wherein said launch data represents an image from said database.

27. The computer readable medium of claim 23 wherein said launch data represents a keyword.

28. The computer readable medium of claim 23 wherein said instructions further control the recording of a weight for each non-verbal association between images of said database.

29. The computer readable medium of claim 28 wherein the instructions for accessing an associated image using said data structure are contingent upon the value of said weight.

30. The method of claim 29 wherein said weight is a concurrence value.

31. A computerized system for searching within a collection of images comprising:
a database relating digitized images;
a computer server coupled to said database; and
a network connection device coupling said computer server to a network;
wherein said database comprises a searchable data structure of nonverbal associations between said images; and
wherein said server communicates with a client on said network to:
(a) receive launch data from said client representing a launch image;
(b) access said database using said launch data; and
(c) transmit a related image to said client that shares a non-verbal association with said launch data in said data structure.

32. The computerized system of claim 31 wherein said non-verbal associations are assigned to said data structure as a result of interest indicated in previous searches by image seekers using said database.

33. The computerized system of claim 31 wherein said server records non-verbal associations between image pairs in said data structure where said nonverbal associations are based upon one or more messages from said client that indicate an interest in said images.

34. The computerized system of claim 31 wherein said server records, in said data structure, non-verbal associations between keywords and images where said non-verbal associations are based upon one or more messages from said client that indicate an interest in said images.

35. The computerized system of claim 34 wherein said launch data represents a keyword and said data structure contains a table of keyword and image pairs.

36. The computerized system of claim 31 wherein said launch data represents a group of images.

37. The computerized system of claim 31 wherein said data structure of said database includes a weight for each said non-verbal association.

38. The computerized system of claim 37 wherein said server's transmission of a related image is contingent upon a comparison between (1) said weight of the shared non-verbal association between said launch data and said related image, and (2) a threshold value.

39. The computerized system of claim 38 wherein said weight is a concurrence value.

40. A method for locating a goal image from a collection of images comprising the steps of:
recording non-verbal associations between images from said collection of images based upon perceived characteristics of said images;
selecting a launch element pertaining to said goal image; and
suggesting a related image where said related image shares a non-verbal association with said launch element.

41. A method for locating a goal image from a collection of images comprising the steps of:
recording associations and concurrence values between pairs of images from said collection of images based upon perceived characteristics shared by the images of each pair of images, said perceived characteristics being identified by image seekers during attempts to locate goal images;
selecting a launch image pertaining to one of said goal images; and
suggesting a related image where said related image shares a non-verbal association with said launch image and said related image satisfies a function of said concurrence value.
